(19) United States
(12) Patent Application Publication
(10) Pub. No.: US 2009/0201496 A1
(43) Pub. Date: Aug. 13, 2009

(54) SURFACE-ENHANCED RAMAN SCATTERING BASED ON NANOMATERIALS AS SUBSTRATE

(76) Inventors: Shuit-Tong Lee, Hong Kong (HK); Ning Bew Wong, Hong Kong (HK); Mingwang Shao, Hong Kong (HK); Mingliang Zhang, Hong Kong (HK)

Correspondence Address: STITES & HARBISON PLLC, 1199 NORTH FAIRFAX STREET, SUITE 900, ALEXANDRIA, VA, 22314, US

(21) Appl. No.: 12/106,751

(22) Filed: Apr. 21, 2008

Related U.S. Application Data
(63) Continuation-in-part of application No. 12/029,064, filed on Feb. 11, 2008, now abandoned.

(51) Int. Cl. G01J 3/44

(52) U.S. Cl. 356/301; 428/403; 977/700

(57) ABSTRACT

The present invention relates to an arrangement of nanomaterials which act as a substrate for a surface-enhanced Raman scattering. A method of Raman scattering and a method of manufacturing the substrate are also disclosed. The substrate comprises a plurality of nanostructures, for example nanowires, and metal nanoparticles are arranged on the surface of the nanostructures. The metal nanoparticles are of a material selected from the group comprising Au, Ag, Cu, Fe, Co, Ni, Ru, Rh, Pd, Pt or an alloy. This nano-on-nano arrangement increase the surface area and provides a significant increase in detection sensitivity. A substrate comprising a nanomaterial substrate form of a plurality of nanostructure of a noble metal and noble metal nanoparticles of a different material on the surface of said nanostructure is also disclosed.

This application is a continuation-in-part of application Ser. No. 12/029,064 filed 11 Feb. 2008 (which is hereby incorporated by reference)

### FIELD OF THE INVENTION

The present invention relates to an arrangement of nanomaterials. The arrangement may be used as a substrate for surface-enhanced Raman scattering detection. The present invention also relates to a method of surface-enhanced Raman scattering detection using a nanomaterial substrate and a method of manufacturing a nanomaterial substrate.

### BACKGROUND OF THE INVENTION

The pioneering work on surface-enhanced Raman scattering (M. Fleischmann, P. J. Hendra and A. J. McQuillan, Chem. Phys. Lett. 26, p 163, 1974) supplied a sensitive detection method to investigate various materials as substrates to enhance Raman scattering. Surface enhanced Raman scattering can provide rich structural information as well as quantitative and qualitative information with regards to chemical reagents that interacts with the substrate surface. The choice of substrate has an important impact in the sensitivity of the method and only certain substrates give high sensitivity.

Usually substrates include electrochemically roughened metal electrodes, chemically deposited, vapor-deposited or photo-reduced metal films, and chemical-etched metal foils. Some substrates are easy to prepare but are not particularly sensitive or reproducible.

By enhancing the surface of the substrate, e.g. by scratching to produce nanoscale lines in the substrate, the sensitivity can be improved.

As nanoscale materials present unique properties attributed to quantum effects arising from its nanometer size and dimensionality, the strong size-dependence of the physical and chemical properties of nanometer-scale materials opens a whole new dimension of sensitive sensors as it enabled a completely new approach to fabricate novel materials with higher enhanced Raman scattering applications. Nanomaterial-based substrates have been investigated (S. Chattopadhyay, H. C. Lo, C. H. Hsu, L. C. Chen and K. H. Chen, Chem. Mater. 17, p 553, 2005); and porous silicon as substrate has also been studied (H. H. Lin, J. Mock, D. Smith, T. Gao and M. J. Sailor, J. Phys. Chem. B, 108, p 11654, 2004). Although considerable progress has been achieved, these substrates are hard to manufacture and the sensitivity and reproducibility of surface-enhanced Raman scattering needs further improvement.

### SUMMARY OF THE INVENTION

It is an object of the present invention to provide a method of surface-enhanced Raman scattering to detect chemicals or biomaterials and substrate for use in such a method which is easy to manufacture and/or provides improved sensitivity.

In very general terms the present invention proposes nanoscale particles of a first material arranged on a nanoscale substrate formed of a second material. Nanoscale materials include, for example, nanowires, nanowiskers, nanoribbons, nanobelts, nanotubes, nanochains, nanocables, nanosheets, nanoparticles, etc.

A first aspect of the present invention provides a substrate for use in Raman scattering detection, the substrate comprising a plurality of nanostructures; and metal nanoparticles arranged on the surface of the nanostructures; said metal nanoparticles being of a different material to said nanostructures; said metal nanoparticles being of a material selected from the group comprising Au, Ag, Cu, Fe, Co, Ni, Ru, Rh, Pd, Pt or alloys comprising at least one of Au, Ag, Cu, Fe, Co, Ni, Ru, Rh, Pd and Pt.

A structured arrangement of a plurality of nanoparticles on a nanomaterials substrate may give enhanced sensitivity, compared to nanoparticles on a conventional substrate, and certain embodiments may be manufactured easily and cheaply in a repeatable manner.

The nanoscale structures may, for example, be nanowires, nanorods, nanochains, nanoribbons, nanotubes, nanocables, nanowiskers or nanobelts.

In this specification ‘nanoscale’ means having a diameter or thickness less than 300 nm, preferably 30 nm or less. Preferably the nanomaterials of the substrate have a diameter or thickness in the range 10-30 nm; more preferably 15-25 nm; 20 nm has been found to give particularly good results.

Preferably at least some of said nanostructures are in contact with each other and partially overlapping

Preferably the nanostructures of the substrate have substantially even diameters throughout their lengths. Substantially even diameter means that for each nanostructure, its diameter does not vary by more than 15% throughout its entire length. The individual nanostructures may, however, have diameters which differ from each other by more than 15%.

Preferably at least some of the metal nanoparticles touch each other.

Preferably the metal nanoparticles are arranged, in a 3D arrangement such that for a given metal nanoparticle there are other metal nano articles arranged above, below and to the sides of said metal nanoparticle.

Preferably more than 30% of the surface of the nanomaterial substrate is covered with said metal nanoparticles.

Preferably more than 50% of the surface of the nanomaterial substrate is covered with said metal nanoparticles.

The nanostructures of the substrate may be formed of organic, polymer, metal or semiconductor nanomaterials. For example the substrate may be formed from a single element such as C, Si, Ge, Sn, Pb, or from a substance comprising two or more elements, e.g. SiC, organic compounds and polymers, etc. The nanoscale substrate may be formed of Au, Ag, Cu, Fe, Co, Ni, Ru, Rh, Pd, Pt or an alloy containing one or more of Au, Ag, Cu, Fe, Co, Ni, Ru, Rh, Pd and Pt). However, in that case the substrate should be formed of a different metal or alloy to the above mentioned arrangement of metal nanoparticles on its surface.

The arrangement of the metal nanoparticles on the nanomaterials substrate may be fabricated via various techniques. The metal nanoparticles may be prepared in advance of the arrangement or synthesized concurrently with the arrangement process. When the metal nanoparticles are prepared in advance of the arrangement, the arrangement may be but not limited to coating, dispersion, deposition, or electrophoretic process onto the nanomaterials substrate; when the metal nanoparticles are synthesized concurrently with the arrangement, the arrangement may be but not limited to the evaporation, deposition, chemical or electrochemical reduction onto the nanomaterials substrate. The preferred method is a chemical method, such as chemical or electrochemical method, for example but not limited to chemical or electrochemical reduction.

The metal nanoparticles arranged on the nanomaterials substrate are then used to detect analyses via surface-enhanced Raman scattering. These nanoparticles can be in the form of but not limited to agglomerate, suspension, solubilized, ensemble or single pieces of nanomaterials.

The substrate according to the first aspect of the present invention is suitable for use in surface-enhanced Raman scattering. Preferred embodiments of the invention may provide improved resolution and detection for surface enhanced Raman scattering and has potential for wide applications in biology, chemistry, physics, environment, and so on.

Preferably the substrate is suitable for use in surface-enhanced Raman scattering to detect chemicals, biomaterials, environmental substances, etc. It may be used to monitor in-situ chemicals, biomaterials, environmental substances, etc. Another possible application is to use the arrangement to monitor in vivo biomaterials via Raman scattering spectroscopy.

Preferred embodiments of the invention may provide enhanced sensitivity such that surface-enhanced Raman scattering might be used to trace analytical capabilities with high structural selectivity and quantitative information from an extremely small sample volume.

One possible application, which the invention may be applied to, is to carry out surface-enhanced Raman scattering in the field of rapid DNA sequencing to characterize specific DNA fragments down to structurally sensitive detention of single base pair without the use of fluorescent or radioactive labels.

A second aspect of the present invention provides a Raman scattering spectrometer comprising a substrate according to the first aspect of the present invention.

A third aspect of the present invention provides a method of Raman scattering spectroscopy comprising the step of providing a substrate according to the first aspect of the present invention and carrying out spectroscopy using said substrate as a substrate for the material being measured.

A fourth aspect of the present invention provides a method of making a substrate comprising the steps of providing a nanomaterial substrate formed of a plurality of nanostructures; and adding metal nanoparticles onto the surfaces of said nanostructures; said metal nanoparticles being of a different material to the nanostructures; said metal nanoparticles being selected from the group comprising Au, Ag, Cu, Fe, Co, Ni, Ru, Rh, Pd, Pt or alloys comprising at least one of Au, Ag, Cu, Fe, Co, Ni, Ru, Rh, Pd and Pt.

In the above aspects of the invention, said nanostructures (e.g. nanowires or nanorods) preferably have substantially uniform diameters along their lengths.

Substantially uniform diameter means that for each nanostructure, its diameter does not vary by more than 15% throughout its entire length. The individual nanostructures (e.g. nanowires or nanorods) may, however, have diameters which differ from each other by more than 15%.

Preferably said metal nanoparticles are substantially evenly distributed along the lengths of the nanostructures (e.g. nanowires or nanorods).

Substantially evenly distributed means that the number of said metal nanoparticles on any 10 nm square area of surface of a nanostructure (e.g. nanorod or nanowire) is not more than 25% greater than the number of said metal nanoparticles on another 10 nm square area of surface the nanostructures.

A fifth aspect of the invention provides a substrate for use in Raman scattering detection, the substrate comprising a plurality of nano particles of a first material arranged on a plurality of nanostructures of a second material.

The first material may be a material selected from the group comprising Au, Ag, Cu, Fe, Co, Ni, Ru, Rh, Pd, Pt or alloys comprising at least one of Au, Ag, Cu, Fe, Co, Ni, Ru, Rh, Pd and Pt as in the first aspect of the present invention. The second material may be organic, polymer, metal or semiconductor materials as mentioned in the first aspect of the invention. Metal or semiconductors (e.g. silicon) are preferred.

Alternatively the first material may be a noble metal or an alloy comprising a noble metal and the second material a noble metal oxysalt or a noble metal alloy oxysalt comprising said noble metal of the first material. Preferably the noble metal is selected from the group comprising Au, Ag, Cu, Ru, Rh, Ta, Pd or Pt. Most preferably the noble metal is silver or gold. The noble metal oxysalt comprises the noble metal of the first material, e.g. if the first material is Au, then the noble metal oxysalt comprises Au also.

An oxysalt is a salt comprising an oxyacid. Any oxyacid is an acid which comprises oxygen. The oxysalt may for example be a bisthumate or vanadate. Other suitable oxysalts include tin oxides, germanates, molybdenate, phosphates and tungstates. For example if silver is the noble metal then suitable noble metal salts include, but are not limited to, Ag₂SnO₃, Ag₈Ge₃O₁₀, Ag₂MoO₄, Ag₃PO₄, Ag₂WO₄. Other possible oxysalts will be apparent to a person skilled in the art.

A noble metal alloy means an alloy comprising at least one noble metal. A noble metal alloy oxysalt is an oxysalt of a noble metal alloy, for example, but not limited to AgCuV₄O₁₀ or AgCuPO₄.

A structured arrangement of noble metal or noble metal alloy particles on a substrate of noble metal oxysalt nanostructures may give enhanced sensitivity compared to nanoparticles on a conventional substrate, and certain embodiments may be manufactured easily and cheaply in a repeatable manner.

The nanoparticles of the first material are preferably formed by placing nanostructures of the second material into contact with a third material having a stronger reducing ability than the noble metal of said noble metal oxysalt or the alloy of said noble metal alloy oxysalt. The third material may be in the form of a metal foil.

The nanostructures may, for example, be nanowires, nanorods, nanochains, nanoribbons, nanotubes, nanocables, nanowiskers, nanobelts, or nanosheets.

In this specification ‘nanoscale’ means having a diameter or thickness less than 300 nm, preferably 30 nm or less. Preferably the nanomaterials of the substrate have a diameter or thickness in the range 10-30 nm; more preferably 15-25 nm; 20 nm has been found to give particularly good results.

Preferably at least some of said nanostructures are in contact with each other and partially overlapping.

Preferably the nanostructures of the first material have substantially even diameters throughout their lengths. Substantially-even diameter means that for each nanostructure, its diameter does not vary by more than 15% throughout its entire length. The individual nanostructures may, however, have diameters which differ from each other by more than 15%.

Preferably at least some of the nanoparticles of the second material touch each other.

Preferably the nanoparticles of the second material are arranged in a 3D arrangement such that for a given metal nanoparticle there are other metal nanoparticles arranged above, below and to the sides of said metal nanoparticle.

Preferably more than 30% of the surface of the nanostructures of the first material is covered with said nanoparticles of the second material.

Preferably more than 50% of the surface of the nanostructures of the first material is covered with said nanoparticles of the second material.

The arrangement of the first material nanoparticles on a second material nanostructures may be fabricated via various techniques. Possible methods of fabrication include, but are not limited to, coating, dispersion, deposition, or electrophoretic process onto the nanomaterials substrate; when the metal nanoparticles are synthesized concurrently with the arrangement, the arrangement may be formed by evaporation, deposition, chemical or electrochemical reduction, but is not limited to these methods.

A substrate comprising noble metal particles on the oxysalt nanostructures may be used to detect analytes via surface-enhanced, Raman scattering. These nanoparticles can be in the form of, but are not limited to, agglomerate, suspension, solubilized, ensemble or single pieces of nanomaterials.

While the nanoparticles may be formed on the surface of said nanostructures by a chemical or electrochemical process, one preferred method is to use a mechanochemical method.

A sixth aspect of the present invention provides a method of forming a substrate according to the fifth aspect of the present invention comprising the steps providing a nanomaterial substrate formed of a plurality of nanostructures of a first material; and forming metal nanoparticles of a second material onto the surfaces of said nanostructures; said first and second materials being different.

Preferably said first material is a noble metal or an alloy comprising a noble metal and said second material is a noble metal oxysalt or a noble metal alloy oxysalt comprising said noble metal of the first material. Preferably said noble metal is selected from the group comprising Au, Ag, Cu, Ru, Rh, Ta, Pd or Pt.

The nanoparticles may be formed by placing nanostructures of the second material into contact with a third material having a stronger reducing ability than the noble metal of said noble metal oxysalt or the alloy of said noble metal alloy oxysalt. The third material then reduces some particles on the surface of the second material to form particles of the first material. The third material may be in the form of a metal foil. The third material may be formed from a single element such as Cu, Sn, Pb, Zn or from a substance comprising two or more elements, e.g. Cu—Ag alloy, organic compounds and polymers, etc. After the reduction process has taken place the third material is preferably discarded and does not become part of the substrate.

The fifth and sixth aspects of the present invention may have any of the features of the first aspect of the present invention, unless the context demands otherwise.

A seventh aspect of the present invention provides a Raman scattering spectrometer comprising a substrate according to the fifth aspect of the present invention.

An eighth aspect of the present invention provides a method of Raman scattering spectroscopy comprising the step of providing a substrate according to the fifth aspect of the present invention and carrying out spectroscopy using said substrate as a substrate for the material being measured.

### BRIEF DESCRIPTION OF THE ARRANGEMENT

Some embodiments of the invention will now be described by way of example and with reference to the accompanying drawings, in which

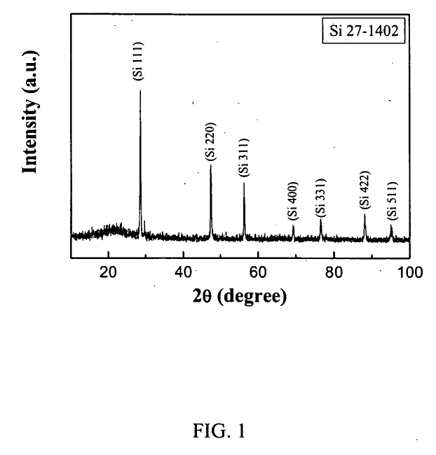

FIG. 1 is an X-ray powder diffraction (XRD) pattern of typical silicon nanowires;

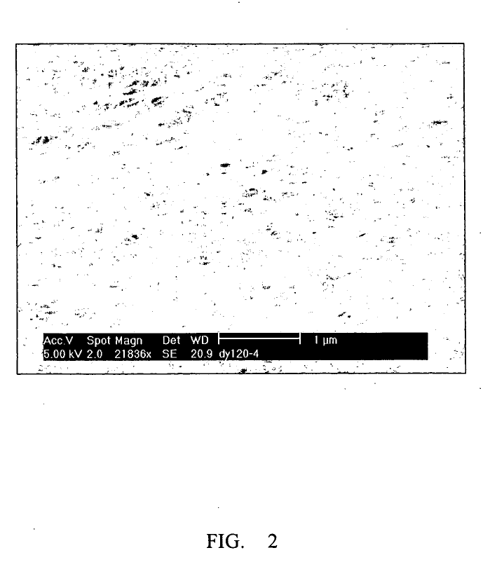

FIG. 2 is a micrograph from a scanning electron microscope (SEM) of silicon nanowires which are suitable to be used as substrates;

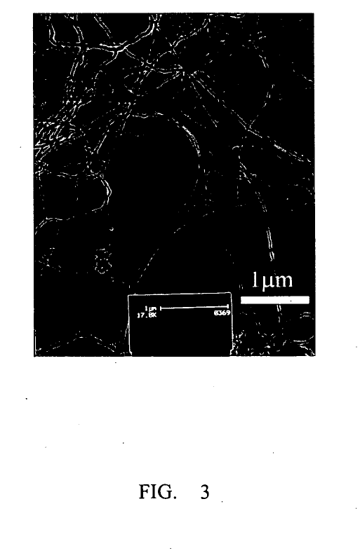

FIG. 3 is a micrograph from a transmission electron microscope (TEM) of silicon nanowires which are suitable to be used as substrates;

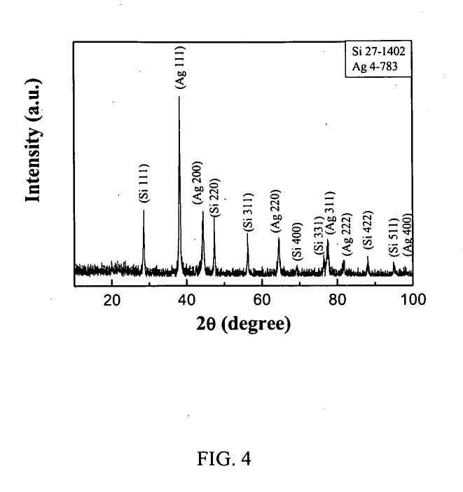

FIG. 4 is an X-ray powder diffraction (XRD) pattern of Ag nanoparticles on the Si nanowires substrate;

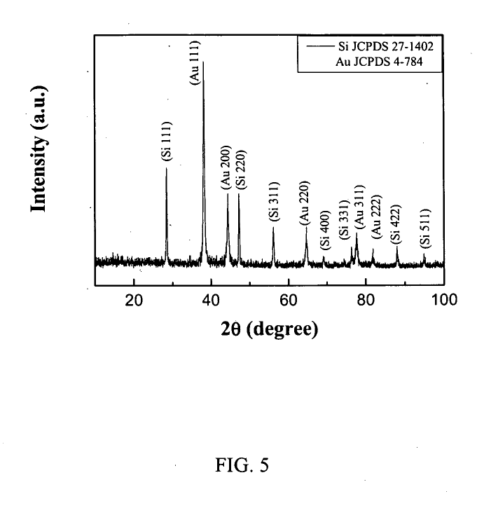

FIG. 5 is an X-ray powder diffraction (XRD) pattern of Au nanoparticles on the Si nanowires substrate;

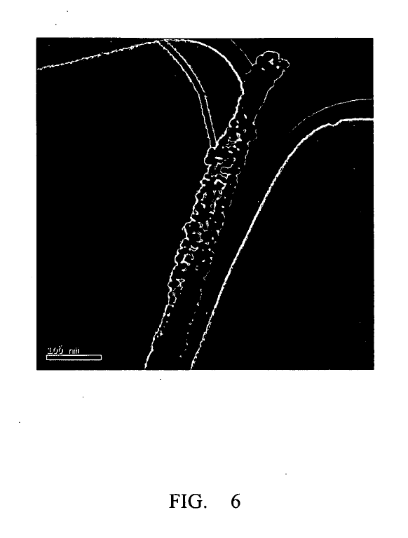

FIG. 6 is a micrograph of a transmission electron microscope (TEM) of Ag nanoparticles arranged onto the surface of a silicon nanowire which is suitable to be used as sensors for surface-enhanced Raman scattering;

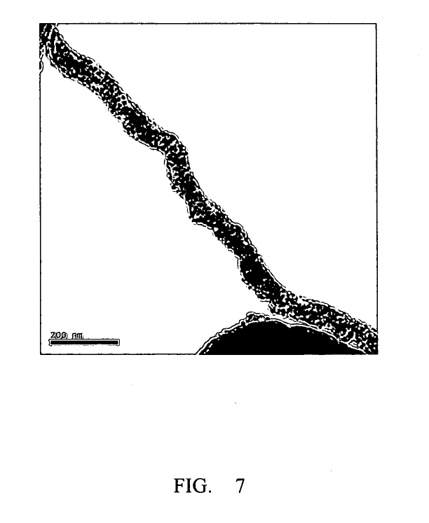

FIG. 7 is a micrograph of a transmission electron microscope (TEM) of Au nanoparticles arranged onto the surface of a silicon nanowire which is suitable to be used as sensors for surface-enhanced Raman scattering; and

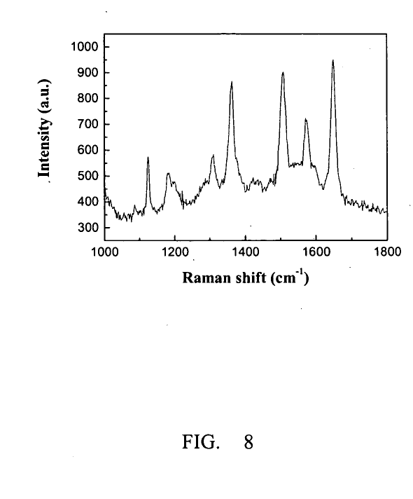

FIG. 8 is an example of surface-enhanced Raman scattering spectrum of 1×10⁻¹⁶ M Rhodamine 6G solution using Ag nanoparticles arranged onto the surface of silicon nanowires.

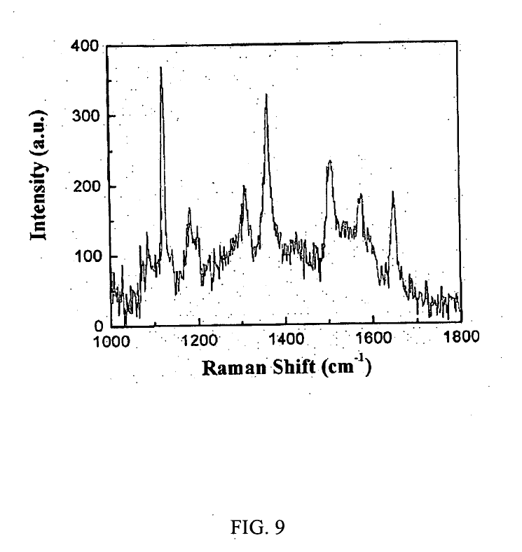

FIG. 9 is an example of surface-enhanced Raman scattering spectrum of 1×10⁻¹⁴M Rhodamine 6G solution using Pd nanoparticles arranged onto the surface of ZnO nanowires.

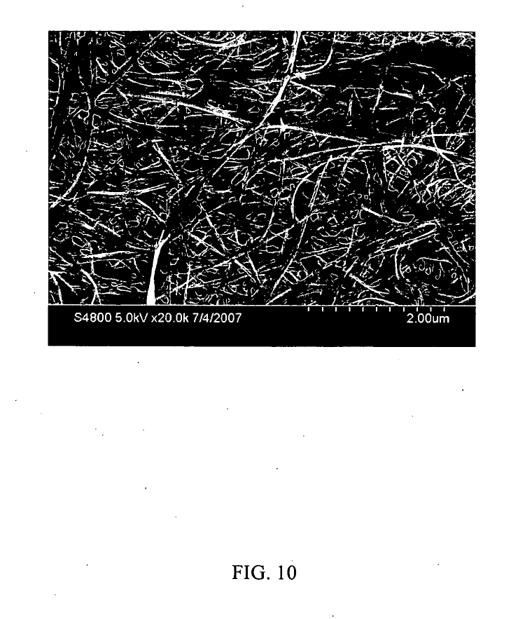

FIG. 10 is a micrograph from a scanning electron microscope (SEM) of silver vanadate nanoribbons which are suitable to be used as substrates;

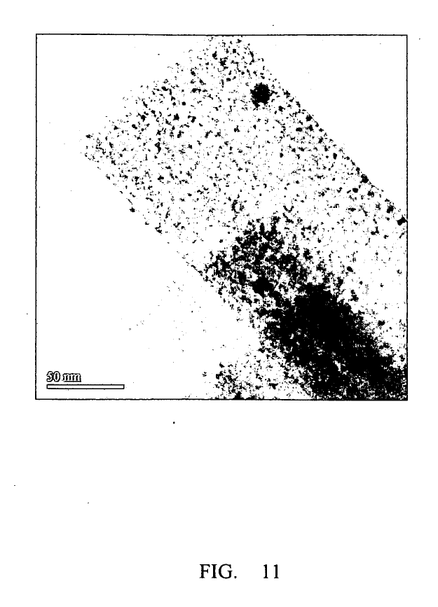

FIG. 11 is a micrograph from a transmission electron microscope (TEM) of silver vanadate nanoribbons which are suitable to be used as substrates;

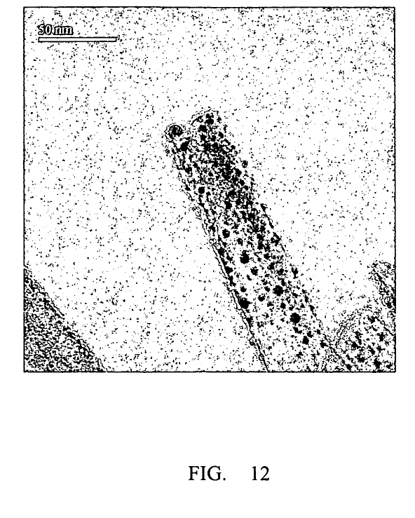

FIG. 12 is a micrograph of a transmission electron microscope (TEM) of Ag nanoparticles arranged onto the surface of a silver nanoribbon which is suitable to be used as sensors for surface-enhanced Raman scattering;

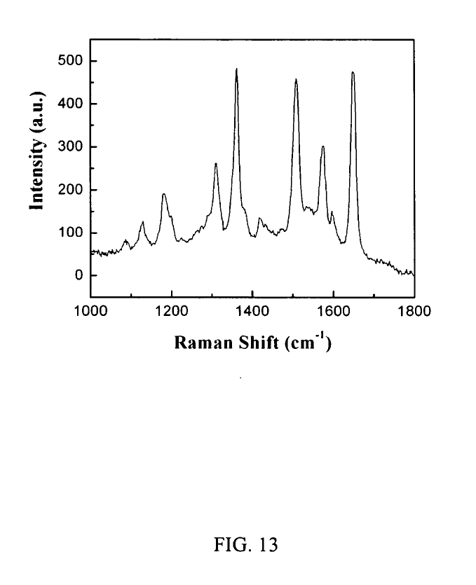

FIG. 13 is an example of surface-enhanced Raman scattering spectrum of 1×10⁻¹⁷ M Rhodamine 6G solution using Ag nanoparticles arranged onto the surface of silver vanadate nanoribbons;

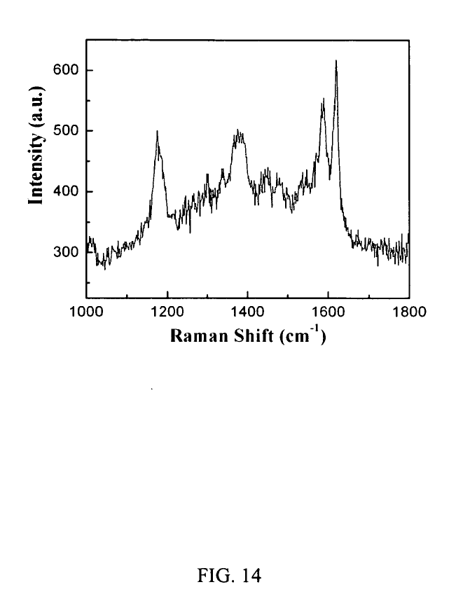

FIG. 14 is an example of surface-enhanced Raman scattering spectrum of 1×10⁻¹⁶ M Rhodamine 6G solution using Ag nanoparticles arranged onto the surface of silver bismuthate nanomaterials;

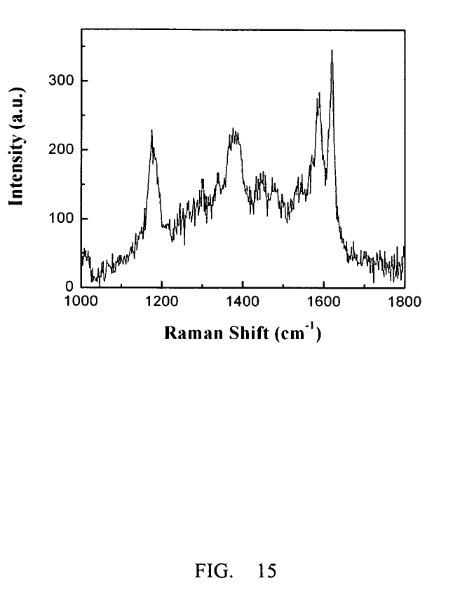

FIG. 15 is an example of surface-enhanced Raman scattering spectrum of 1×10⁻¹⁴ M Rhodamine 6G solution using Au nanoparticles arranged onto the surface of gold molybdate nanomaterials.

### EXAMPLES

The following examples are presented to illustrate and provide further understanding of the invention.

### Example A

The silicon nanowires used as the substrate are synthesized via various nanowire synthetic methods including but not limited to the oxide-assisted growth (U.S. Pat. No. 6,313,015 (2001), Zhang, Lee et al. Adv. Mat. 15 (2003) 635, Lee et al. MRS Bulletin 24 (1999) 36, Lee et al., J. Mat. Res. 14 (1999) 4603), metal-catalyzed vapor-liquid-solid method (Wang, Lee et al., Chem. Phys. Letts. 283 (1998) 368, Zhang, Lee et al., Appl. Phys. Letts. 72 (1998) 1835, D. P. Yu et al., Solid State Comm. (1998), C. Lieber et al., Science 279 (1998) 208), vapor-solid method, and solvothermal method. X-ray powder diffraction (XRD) pattern of the current example is shown in FIG. 1. All the intense peaks can be indexed to a cubic lattice, which is in agreement with the diamond-cubic silicon (JCPDS file: 27-1402, a=0.5430 nm). Micrographs obtained from scanning electron microscopy (SEM) and transmission electron microscopy (TEM) are shown in FIG. 2 and FIG. 3 respectively. The silicon nanowires are treated with HF aqueous solution. The concentration of HF aqueous solution is 5%. The treatment time is 30 minute. Afterwards, the silicon nanowires are rinsed with distilled water and dipped into AgNO₃ aqueous solution. The concentration of AgNO₃ solution is 1×10⁻² M; the time is 5 minute; the temperature is around 80° C. The AgNO₃ is reduced to Ag nanoparticles by the H-terminated surface of silicon nanowires, and the particles are arranged on the surface of Si nanowires. The Ag nanoparticles are quite uniform and isolated from each other or some are in touch with each other. The size and density of the resulting Ag nanoparticles can be changed by the concentration and temperature of AgNO₃ solution as well as the reaction time. FIG. 4 shows the diffraction pattern of the Ag wires on the Si nanowire substrate. FIG. 6 shows the TEM image of the Ag nanoparticles on the Si nanowire substrate. When a drop (ca. 0.025 ml) of Rhodamine 6G solution of 1×10⁻¹⁶M (dissolved in methanol solution) is added on the substrate, it is analyzed with surface-enhanced Roan scattering. FIG. 8 presents the SERS spectrum of the Rhodamine-treated substrate. The peaks in the Raman spectrum are strong and confirm the presence of Rhodamine 6G although the concentration is orders of magnitude below the previous reported detecting limits (1×10⁻¹⁴ M Rhodamine 6G by G. Wei, H. L, Zhou, Z. G. Liu and Z. Li, Appl. Surf. Sci. 240, p 260, 2005; 1×10⁻¹⁰ M Rhodamine 6G for S. Chattopadhyay, H. C. Lo, C. H. Hsu, L. C. Chen and K H. Chen, Chem. Mater. 17, p 553, 2005).—FIG. 9

### Example B

The silicon nanowires used as the substrate are synthesized via various nanowire synthetic methods including but not limited to the oxide-assisted growth (U.S. Pat. No. 6,313,015 (2001), Zhang, Lee et al. Adv. Mat. 15 (2003) 635, Lee et al. MRS Bulletin 24 (1999) 36, Lee et al., J. Mat. Res. 14 (1999) 4603), metal-catalyzed vapor-liquid-solid method (Wang, Lee et al., Chem. Phys. Letts. 283 (1998) 368, Zhang, Lee et al., Appl. Phys. Letts. 72 (1998) 1835, D. P. Yu et al., Solid State Comm. (1998), C. Lieber et al., Science 279 (1998) 208), vapor-solid method, and solvothermal method. X-ray powder diffraction (XRD) pattern of the current example is shown in FIG. 1. All the intense peaks can be indexed to a cubic lattice, which is in agreement with the diamond-cubic silicon (JCPDS file: 27-1402, a=0.5430 nm). Micrographs obtained from scanning electron microscopy (SEM) and transmission electron microscopy (TEM) are shown in FIG. 2 and FIG. 3 respectively. The silicon nanowires are treated with HF aqueous solution. The concentration of HF aqueous solution is 5%. The treatment time is 30 minute. Afterwards, the silicon nanowires are rinsed with distilled water and dipped into AuCl₃ aqueous solution. The concentration of AuCl₃ solution is 1×10⁻² M; the time is 5 minute; the temperature is around 80° C. The AuCl₃ is reduced to Au nanoparticles by the H-terminated surface of silicon nanowires, and the particles are arranged on the surface of Si nanowires. The Au nanoparticles are quite uniform and isolated from each other or some are in touch with each other. The size and density of the resulting Au nanoparticles can be changed by the concentration and temperature of AuCl₃ solution as well as the reaction time. FIG. 5 shows the diffraction pattern of the Au particles on the Si nanowires substrate. FIG. 7 shows the TEM image of the Au nanoparticles on the Si nanowire substrate. When a drop (ca 0.025 ml) of Rhodamine 6G solution of 1×10⁻¹⁶ M (dissolved in methanol solution) is added on the substrate, it is analyzed with surface-enhanced Raman scattering.

### Example C

The ZnO nanorods used for the substrate are synthesized via various nanowires synthetic methods including but not limited to the high temperature route, vapor-solid method, and solvothermal method (Zhou, Lee et al. Phys. Status Solidi A, 202 (2005) 405, Zhou, Lee et al. Nanotechnology 15 (2004) 1152, Geng, lee et al. Adv. Func. Mat. 14 (2004) 589, Liu, Lee et al. Appl. Phys. Lett. 83 (2003) 3168, Liu, Lee et al., Adv. Mater. 15 92003) 838, Hu, Lee et al., Chem. Mater. 15 (2003) 305, Tang, Qian et al. Chem. Commun. 8 (2004) 712). The ZnO nanowires are deposited with Pd nanoparticles via PdCl₂ with reducer such as NaBH₄, KBH₄, glucose et al. The concentration of PdCl₂ solution is 1×10⁻³M. The deposition time is 30 minute and the temperature is at room temperature. When a drop (ca. 0.025 ml) of Rhodamine 6G solution of 1×10⁻¹⁴M (dissolved in methanol solution) is added on the substrate, it is analyzed with surface-enhanced Raman scattering. FIG. 9 presents the SERS spectrum of the Rhodamine-treated substrate. The peaks in the Raman spectrum are strong and confirm the presence of Rhodamine 6G.

### Example D

In this example silver vanadate nanostructures are used as the second material of the substrate. In this example the nanostructures are nanoribbons, but nanowires, nanorods, nanochains, nanotubes, nanocables, nanowiskers, nanobelts, nanosheets or other nanostructures could be used instead. The nanostructures may be synthesized via various synthetic methods including but not limited to the solution methods (e.g. as described in Li, Shao et al. Solid State Ionics, 178 (2007) 775), mechanosyntheses (e.g. as described in Nowinski, Vadillo et al. J. Power Sources 173 (2007) 806), and template assisted methods (e.g. as described in Sharma and Panthofer et al, Mater. Lett. 91 (2005) 257). Micrographs of the nanoribbons, obtained from scanning electron microscopy (SEM) and transmission electron microscopy (TEM), are shown in FIG. 10 and FIG. 11 respectively.

The silver vanadate nanoribbons react with a third material having greater reducing ability than silver via a mechanochemical method. In this example the third material is copper foil. Specifically, copper foil was cut into 10 mm×10 mm pieces in size and washed with acetone, ethanol, and distilled water in an ultrasonic apparatus for 5 min successively; and dried naturally. Then 0.001 g AgVO₃ nanoribbons were added onto the copper foil and grounded for 1 minute. However the general, principle is that the third material is contacted physically with the second material for a period of time.

By this method some of the Ag ions in the silver vanadate are reduced to Ag nanoparticles (the first material) by the copper foil, and the Ag nanoparticles are arranged on the surface of silver vanadate nanoribbons (the second material). The Ag nanoparticles may be quite uniform and isolated from each other, but some may be in touch with each other. The size and density of the Ag nanoparticles, resulting from the above process, can be changed by varying the reaction temperature and the reaction time of the process. The copper foil (the third material) was discarded and does not become part of the substrate.

FIG. 12 shows a TEM image of the Ag nanoparticles on a silver vanadate nanostructure substrate. When a drop (ca. 0.025 ml) of Rhodamine 6G solution of 1×10⁻¹⁷ M (dissolved in methanol solution) is added on the substrate, it is analyzed with surface-enhanced Raman scattering. FIG. 13 presents the SERS spectrum of the Rhodamine-treated substrate. The peaks in the Raman spectrum are strong and confirm the presence of Rhodamine 6G although the concentration is orders of magnitude, below the previously reported detecting limits using conventional techniques. For example, the previously reported limits were 1×4 M Rhodamine 6G by G. Wei, H. L. Zhou, Z. G. Liu and Z. Li, Appl. Surf. Sci. 240, p 260, 2005; 1×10⁻¹⁰M Rhodamine 6G for S. Chattopadhyay, H. C. Lo, C. H. Hsu, L. C. Chen and K. H. Chen, Chem. Mater. 17, p 553, 2005). However this Example D of the present invention is capable of Rhodamine 6G solution of 1×10⁻¹⁷M.

### Example E

In this example silver bismuthate nanostructures are used as the second material. In this example the nanostructures are nanoribbons, but nanowires, nanorods, nanochains, nanotubes, nanocables, nanowiskers, nanobelts, nanosheets or other nanostructures could be used instead. The nanostructures may be synthesized via various synthetic methods including but not limited to solvothermal methods (e.g. as described in Oldag, Aussieker et al. Zeitschrift Fur Anorganische Und Algemeine Chemie, 631 (2005) 677), solution syntheses (e.g. as described in Obemdorfer and Jansen, Zeitscluift Fur Anorganische Und Allgemeine Chemie, 628 (2002) 1951), and high temperature methods (e.g. as described in Bortz and Jansen, Zeitschrift Fur Anorganische Und Allgemeine Chemie, 619 (1993) 1446).

The silver bismuthate nanostructures are reacted with a foil of a third material via a mechanochemical method. The third material has a greater reducing ability than the noble metal of the first material. In this example the third material is iron foil. Specifically, iron foil was cut into 10 mm×10 mm pieces in size and washed with acetone, ethanol, and distilled water in an ultrasonic apparatus for 5 min successively; and dried naturally. Then 0.001 g AgVO₃ nanoribbons were added onto the iron foil and grounded for 1 minute. However the general principle is that the third, material is contacted physically with the second material for a period of time.

By this method some of the Ag ions are reduced to Ag nanoparticles by the iron, and these Ag nanoparticles (the first material) are arranged on the surface of silver bismuthate nanostructures (the second material). The Ag nanoparticles may be quite uniform and isolated from each other or some may be in touch with each other. The size and density of the resulting Ag nanoparticles can be changed by changing the reaction temperature and the reaction time. The iron foil (the third material) was discarded and does not become part of the substrate.

When a drop (ca. 0.025 ml) of Rhodamine 6G solution of 1×10⁻¹⁶ M (dissolved in methanol solution) is added on the substrate, it is analyzed with surface-enhanced Raman scattering FIG. 14 presents the SERS spectrum of the Rhodamine-treated substrate. The peaks in the Raman spectrum are strong and confirm the presence of Rhodamine 6G although the concentration is orders of magnitude below the previous reported detecting limits using conventional techniques. For example the previously reported limit was 1×10⁻¹⁴ M Rhodamine 6G by G. Wei, H. L. Zhou, Z. G. Liu and Z. Li, Appl. Surf. Sci. 240, p 260, 2005; 1×10⁻¹⁰ M Rhodamine 6G for S. Chattopadhyay, H. C. Lo, C. H. Hsu, L. C. Chen and K. H. Chen, Chem. Mater. 17, p 553, 2005). However Example D of the present invention makes it possible to detect Rhodamine 6G solution of 1×10⁻¹⁶M.

### Example F

In this example gold molybdate nanostructures are used as the second material of the substrate. In this example the nanostructures are nanoribbons, but nanowires, nanorods, nano chains, nanotubes, nano cables, nanowiskers, nanobelts, nanosheets or other nanostructures could be used instead. The nanostructures may be synthesized via various synthetic methods including, but not limited to solution methods (e.g. as described in Li, Sheng et al. Chinese J. Ana. Chem. 27 (1999) 1080) and poly-vinyl alcohol assisted methods (e.g. as described in Li, Wang et al., Mikrochimica Acta, 4 (1994) 219).

The gold molybdate nanostructures are placed in contact with and react with a third material via a mechanochemical method. The third material has a greater reducing ability than the noble metal of the first material. In this example the third material is zinc foil. Specifically, zinc foil was cut into 10 mm×10 mm pieces in size and washed with acetone, ethanol, and distilled water in an ultrasonic apparatus for 5 min successively, and dried naturally. Then 0.001 g AgVO₃ nanoribbons were added onto the zinc foil and grounded for 1 minute. However the general principle is that the third material is contacted physically with the second material for a period of time.

Some of the Au ions of the gold molybdate are reduced to Au nanoparticles by the zinc foil. The Au nanoparticles (the first material) are arranged on the surface of gold molybdate nanostructures (the second material. The Au nanoparticles may be quite uniform and isolated from each other or some may touch each other. The size and density of the resulting Au nanoparticles can be changed by changing the reaction temperature and the reaction time. The zinc foil (the third material) was discarded and does not become part of the substrate.

A drop (ca. 0.025 ml) of Rhodamine 6G solution of 1×10⁻¹⁴ M (dissolved in methanol solution) was added to the substrate and analyzed with surface-enhanced Raman scattering. FIG. 15 presents the SERS spectrum of the Rhodamine-treated substrate. The peaks in the Raman spectrum are strong and confirm the presence of Rhodamine 6G although the concentration is orders of magnitude below the previous reported detecting limits using conventional techniques. For example a previously reported limit was 1×10⁻¹⁴M Rhodamine 6G by G. Wei, H. L. Zhou, Z. G. Liu and Z. Li, Appl. Surf. Sci. 240, p 260, 2005; 1×10⁻¹⁰ M Rhodamine 6G for S. Chattopadhyay, H. C. Lo, C. H. Hsu, L. C. Chen and K. H. Chen, Chem. Mater. 17, p 553, 2005. However, example F of the present invention makes it possible to detect Rhodamine 6G solution of 1×10⁻¹⁴M.

1. A substrate for use in Raman scattering detection, the substrate comprising a plurality of nanostructures; and metal nanoparticles arranged on the surface of the nanostructures; said metal nanoparticles being of a different material to said nanostructures; said metal nanoparticles being of a material selected from the group comprising Au, Ag, Cu, Fe, Co, Ni, Ru, Rh, Pd, Pt or alloys comprising at least one of Au, Ag, Cu, Fe, Co, Ni, Ru, Rh, Pd and Pt.

2. The substrate of claim 1 wherein the nanostructures are nanowires, nanorods, nanotubes, nanoribbons or nanochains.

3. The substrates of claim 1 wherein at least some of said nanostructures are in contact with each other and partially overlapping.

4. The substrate of claim 1 wherein said metal nanoparticles have been added to the surface of said nanostructures by a chemical or electrochemical process.

5. The substrate of claim 1 wherein the nanostructures are formed of metal materials.

6. The substrate of claim 1 wherein the nanostructures are formed of silicon.

7. The substrate of claim 1 wherein the nanostructures have substantially even diameter throughout their length.

8. The substrate of claim 1 wherein at least some of the metal nanoparticles are arranged to be touching each other.

9. The substrate of claim 1 wherein the metal nanoparticles are arranged in a 3D arrangement such that for a given metal particle there are other metal nanoparticles arranged above, below and to the sides of said metal nanoparticle.

10. The substrate of claim 1 wherein more than 30% of the surface of the nanowires and nanorods are covered with said metal nanoparticles.

11. The substrate of claim 1 wherein more than 50% of the surface of said nanowires and nanorods is covered with said metal nanoparticles.

12. The substrate of claim 1 wherein said arrangement is suitable for use as a substrate for surface-enhanced Raman scattering.

13. A Raman scattering spectrometer comprising a substrate according to claim 1.

14. A method of Raman scattering spectroscopy comprising the step of providing a substrate according to claim 1 and carrying out spectroscopy using said substrate as a substrate for the material being measured.

15. The substrate of claim 1 wherein the nanostructures have a diameter or thickness of 10-30 nm.

16. The arrangement of claim 1 wherein said metal nanoparticles have a diameter of 10-30 nm.

17. A method of making a substrate comprising the steps of providing a nanomaterial substrate formed of a plurality of nanostructures; and adding metal nanoparticles onto the surfaces of said nanostructures; said metal nanoparticles being of a different material to the nanostructures; said metal nanoparticles being selected from the group comprising Au, Ag, Cu, Fe, Co, Ni, Ru, Rh, Pd. Pt or alloys comprising at least one of Au, Ag, Cu. Fe, Co, Ni, Ru, Rh, Pd and Pt.

18. The method of claim 17 wherein said metal nanoparticles are added to the surfaces of the nanostructures by a chemical or electrochemical process.

19. The method of claim 17 wherein said nanostructures are nanowires, nanorods, nanochains, nanoribbons or nanotubes.

20. The method of claim 17 wherein said metal nanoparticles are added by a process selected from the group comprising coating, deposition, evaporation, co-deposition, decomposition, chemical reduction or electrochemical reduction.

21. A substrate for use in Raman scattering detection, the substrate comprising a plurality of nano particles of a first material arranged on a plurality of nanostructures of a second material.

22. The substrate of claim 21 wherein said first material is a noble metal or an alloy comprising a noble metal and said second material is a noble metal oxysalt or a noble metal alloy oxysalt comprising said noble metal of the first material.

23. The substrate of claim 21 wherein said noble metal is selected from the group comprising Au, Ag, Cu, Ru, Rh, Ta, Pd or Pt.

24. The substrate of claim 23 wherein the nanostructures are nanowires, nanorods, nanotubes, nanoribbons or nanochains.

25. The substrates of claim 24 wherein at least some of said nanostructures are in contact with each other and partially overlapping.

26. A method of making a substrate comprising the steps of providing a nanomaterial substrate formed of a plurality of nanostructures of a first material; and forming metal nanoparticles of a second material onto the surfaces of said nanostructures; said first and second materials being different.

27. The method of claim 26 wherein said first material is a noble metal or an alloy comprising a noble metal and said second material is a noble metal oxysalt or a noble metal alloy oxysalt comprising said noble metal of the first material.

28. The method of claim 26 wherein said noble metal is selected from the group comprising Au, Ag, Cu, Ru, Rh, Ta, Pd or Pt.

29. The substrate of claim 26 wherein said metal nanoparticles have been formed on the surface of said nanostructures by a chemical or electrochemical process.

30. The substrate of claim 27 wherein said nanoparticles are formed by placing nanostructures of the second material in contact with a third material having a stronger reducing ability than the noble metal of said noble metal oxysalt or noble metal alloy oxysalt.
